(19) United States
(12) Patent Application Publication
(10) Pub. No.: US 2004/0156010 A1
(43) Pub. Date: Aug. 12, 2004

(54) Mini computer glasses

(76) Inventor: Norman P. Einhorn, Wayside, NJ (US)

Correspondence Address: Arthur M. Peslak, Esq., MANDEL & PESLAK, LLC, Suite 5, 80 Scenic Drive, Freehold, NJ, 07728, US

(21) Appl. No.: 10/442,060

(22) Filed: Feb. 10, 2003

(51) Int. Cl. G02C 1/00

(52) U.S. Cl. 351/41

(57) ABSTRACT

A mini pair of eyeglasses for reducing computer related stress are disclosed. The eyeglasses include a frame adapted to rest on the end of the user's nose and a miniature lens that is designed to reduce computer related visual stress during computer monitor use.

### BACKGROUND OF THE INVENTION

The present invention is directed to the field of corrective eyeglasses. In particular, the present invention is directed to eyeglasses for use in connection with viewing a computer screen. The lenses of the present invention are useful in reducing visual problems associated with prolonged computer usage such as visual muscle fatigue, blurred vision and headaches.

### SUMMARY OF THE INVENTION

The present invention is directed to a miniature pair of eyeglasses for reducing computer related visual stress. The eyeglasses comprise a frame adapted to fit on the user's nose with lenses no more than 20 mm in height and at least 40 mm long. The lens can also comprise a tint, prism and low power correction.

### BRIEF DESCRIPTION OF THE DRAWINGS

FIG. 1 is a plan view of the device of the present invention.

FIG. 2 illustrates the intended use of the device of the present invention.

### DETAILED DESCRIPTION OF THE INVENTION

The presently preferred embodiment of the present invention will now described in connection with the appended drawings. However, this embodiment is merely one example of the present invention and the claims should not be limited in scope by this embodiment.

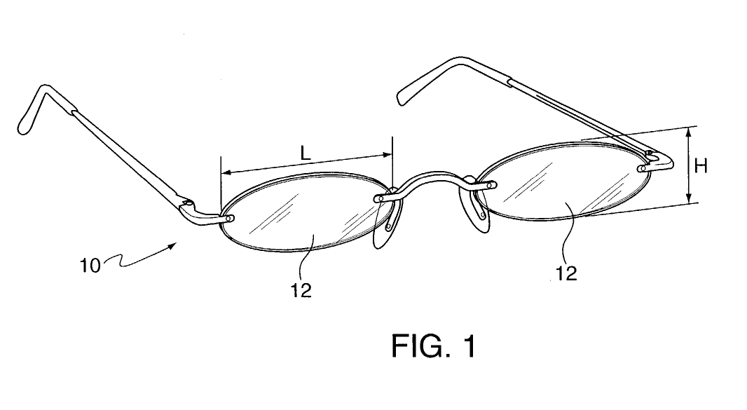

The present invention is directed to a miniature pair of eyeglasses 10 as shown in FIG. 1. The lenses 12 are of a height H that is no more than approximately 20 mm. The length L of the lenses 12 are at least approximately 40 mm. The dimensions H and L of the lenses 12 are designed to allow for viewing of a computer monitor 14 at standard distances.

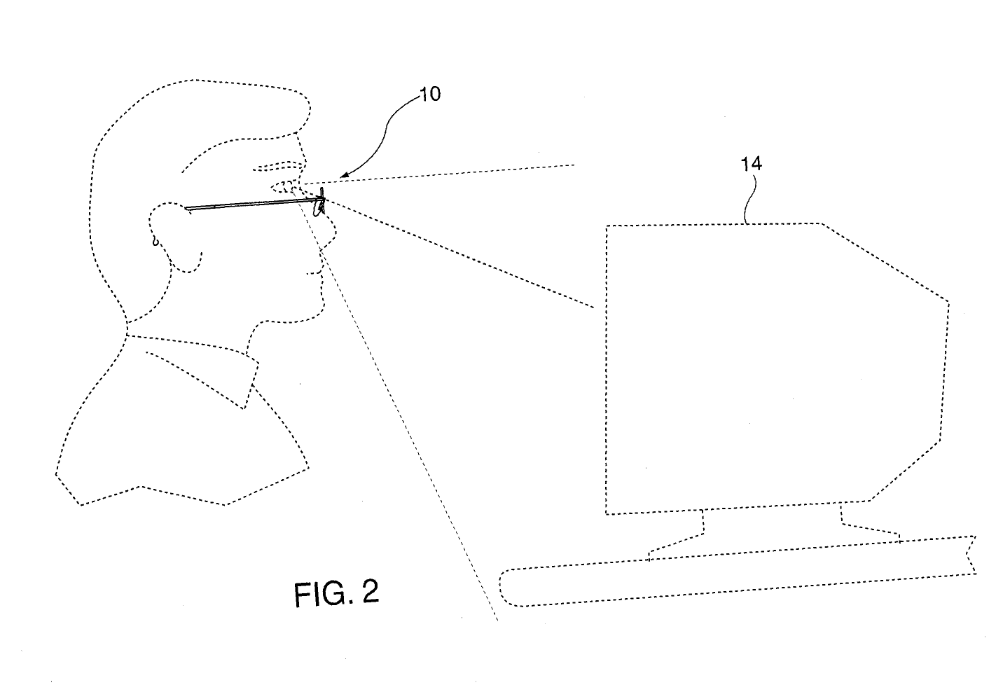

As shown in FIG. 2 the eyeglasses 10 are set near the end of the nose of the user much like standard reading glasses. This positioning of the eyeglasses 10 allows for viewing of the computer monitor 14 through the lens 12. At the same time, the user can look above the lenses 12 for unencumbered distance viewing. The user can also look below the lenses 12 for unencumbered near vision for either keyboard viewing, reading or writing.

The lenses 12 can also be provided with a tint having a 12% absorption of incident light. The color used for the tint is normally sand. The lenses 12 are also provided with prism of 0.25 to 0.50 diopters in order to reduce computer glare, light sensitivity and muscle fatigue. The use of low power correction up to +2.00 will reduce focus related stress which often occurs when one uses a computer for extended periods of time. This combination of visual correction in the lenses 12 of the present invention creates a lens 12 that is specifically directed to alleviating visual stresses associated with computer use. The lenses 12 reduce the problems caused by computer stress such as headaches, intermittent blur and visual fatigue. However, the arrangement of the lenses 12 are in the overall eyeglasses 10 leaves the remainder of the visual environment in the normal visual state without the need for costly and cumbersome bifocals, trifocals, progressives, full reading glasses or standard half eye reading glasses.

The unique lens size, in relations to the distance to the monitor, as well as monitor size, allows for minimal head and neck movement especially when alternating from the monitor to the keyboard to other objects and back to the monitor. The present invention also decreases abnormal posture that is inherently created by most computer glasses or reading glasses used at the computer. This decreased head, neck, and shoulder movement, reduces strain, and pain that often leads to headaches and orthopedic repetitive stress problems.

Those of ordinary skill in the art will recognize that the embodiments just described merely illustrate the principles of the present invention. Many modifications may be made thereto without departing from the spirit and scope of the invention as set forth in the following claims.

What is claimed is:

1) Eyeglasses for reading computer related visual problems comprising:
a) a frame adapted to fit on the eyeglass user's nose; and
b) lenses adapted to fit the frame wherein the lenses are of height no greater than 20 mm and of a length of at least 40 mm whereby a user of the eyeglasses can look through the lens a computer screen but have unencumbered vision above and below the lens.

2) The eyeglasses of claim 1 wherein the lenses comprise a tint.

3) The eyeglasses of claim 2 wherein the tint absorbs up to 12% of incident light.

4) The eyeglasses of claim 2 wherein the lenses further comprise prism.

5) The eyeglasses of claim 4 wherein the prism is in the range of 0.25 to 0.50 diopters.

6) The eyeglasses of claim 4 wherein the lenses further comprise low power correction.

7) The eyeglasses of claim 6 wherein the low power correction is provided at up to +2.00.
